(19) United States
(12) Patent Application Publication
(10) Pub. No.: US 2006/0142429 A1
(43) Pub. Date: Jun. 29, 2006

(54) Retention and drainage in the manufacture of paper

(76) Inventors: Robert A. Gelman, Newark, DE (US); John C. Harrington, Jacksonville, FL (US); Frank J. Sutman, Jacksonville, FL (US)

Correspondence Address: Joanne Mary Fobare Rossi;Hercules Incorporated, Hercules Plaza, 1313 North Market Street, Wilmington, DE, 19894-0001, US

(21) Appl. No.: 11/313,313

(22) Filed: Dec. 21, 2005

Related U.S. Application Data
(60) Provisional application No. 60/640,157, filed on Dec. 29, 2004.

(51) Int. Cl. B29C 47/00; D21H 21/10; D21H 17/33

(52) U.S. Cl. 524/13; 162/168.1; 162/175; 162/179; 162/181.6; 162/183; 162/158; 524/505

(57) ABSTRACT

A method of improving retention and drainage in a papermaking process is disclosed. The method provides for the addition of an associative polymer, a water compatible polymer and optionally a siliceous material to the papermaking slurry. Additionally, a composition comprising an associative polymer, and a water compatible polymer and optionally further comprising cellulose fiber is disclosed.

This application claims the benefit of U.S. Provisional Application No. 60/640,157, filed Dec. 29, 2004, the entire content of which is herein incorporated by reference.

### FIELD OF THE INVENTION

This invention relates to the process of making paper and paperboard from a cellulosic stock, employing a flocculating system.

### BACKGROUND

Retention and drainage is an important aspect of papermaking. It is known that certain materials can provide improved retention and/or drainage properties in the production of paper and paperboard.

The making of cellulosic fiber sheets, particularly paper and paperboard, includes the following: 1) producing an aqueous slurry of cellulosic fiber which may also contain inorganic mineral extenders or pigments; 2) depositing this slurry on a moving papermaking wire or fabric; and 3) forming a sheet from the solid components of the slurry by draining the water.

The foregoing is followed by pressing and drying the sheet to further remove water. Organic and inorganic chemicals are often added to the slurry prior to the sheet-forming step to make the papermaking method less costly, more rapid, and/or to attain specific properties in the final paper product.

The paper industry continuously strives to improve paper quality, increase productivity, and reduce manufacturing costs. Chemicals are often added to the fibrous slurry before it reaches the papermaking wire or fabric to improve drainage/dewatering and solids retention; these chemicals are called retention and/or drainage aids.

Drainage or dewatering of the fibrous slurry on the papermaking wire or fabric is often the limiting step in achieving faster paper machine speeds. Improved dewatering can also result in a drier sheet in the press and dryer sections, resulting in reduced energy consumption. In addition, as this is the stage in the papermaking method that determines many of the sheet final properties, the retention and/or drainage aid can impact performance attributes of the final paper sheet.

With respect to solids, papermaking retention aids are used to increase the retention of fine furnish solids in the web during the turbulent method of draining and forming the paper web. Without adequate retention of the fine solids, they are either lost to the mill effluent or accumulate to high levels in the recirculating white water loop, potentially causing deposit buildup. Additionally, insufficient retention increases the papermakers' cost due to loss of additives intended to be adsorbed on the fiber. Additives can provide opacity, strength, sizing or other desirable properties to the paper.

High molecular weight (MW) water-soluble polymers with either cationic or anionic charge have traditionally been used as retention and drainage aids. Recent development of inorganic microparticles, when used as retention and drainage aids, in combination with high MW water-soluble polymers, have shown superior retention and drainage efficacy compared to conventional high MW water-soluble polymers. U.S. Pat. Nos. 4,294,885 and 4,388,150 teach the use of starch polymers with colloidal silica. U.S. Pat. Nos. 4,643,801 and 4,750,974 teach the use of a coacervate binder of cationic starch, colloidal silica, and anionic polymer. U.S. Pat. No. 4,753,710 teaches flocculating the pulp furnish with a high MW cationic flocculant, inducing shear to the flocculated furnish, and then introducing bentonite clay to the furnish.

The efficacy of the polymers or copolymers used will vary depending upon the type of monomers from which they are composed, the arrangement of the monomers in the polymer matrix, the molecular weight of the synthesized molecule, and the method of preparation.

It had been found recently that water-soluble copolymers when prepared under certain conditions exhibit unique physical characteristics. These polymers are prepared without chemical cross linking agents. Additionally, the copolymers provide unanticipated activity in certain applications including papermaking applications such as retention and drainage aids. The anionic copolymers which exhibit the unique characteristics were disclosed in WO 03/050152 A1, the entire content of which is herein incorporated by reference. The cationic and amphoteric copolymers which exhibit the unique characteristics were disclosed in U.S. Ser. No. 10/728,145, the entire content of which is herein incorporated by reference.

The use of inorganic particles with linear copolymers of acrylamide, is known in the art. Recent patents teach the use of these inorganic particles with water-soluble anionic polymers (U.S. Pat. No. 6,454,902) or specific crosslinked materials (U.S. Pat. No. 6,454,902, U.S. Pat. No. 6,524,439 and U.S. Pat. No. 6,616,806).

However, there still exists a need to improve drainage and retention performance.

### SUMMARY OF THE INVENTION

A method of improving retention and drainage in a papermaking process is disclosed. The method provides for the addition of an associative polymer and a water compatible polymer to a papermaking slurry.

Additionally, a composition comprising an associative polymer and a water compatible polymer and optionally further comprising cellulose fiber is disclosed.

Additionally, a composition comprising an associative polymer, a water compatible polymer, a siliceous material and optionally further comprising cellulose fiber is disclosed.

### DETAILED DESCRIPTION OF THE INVENTION

The present invention provides for a synergistic combination comprising a water soluble copolymer prepared under certain conditions (herein after referred to as “associative polymer”) and water compatible polymers. It has surprising been found that this synergistic combination results in retention and drainage performance superior to that of the individual components. Synergistic effects occur when the combination of components are used together.

It has been found, unexpectedly, that the use of water compatible polymers in combination with an associative polymer (such as the polymer disclosed in WO 03/050152 A1 or US 2004/0143039 A1) results in enhanced retention and drainage.

The present invention also provides for a novel composition comprising an associative polymer and a water compatible polymer.

The present invention also provides for a composition comprising an associative polymer, water compatible polymer and a siliceous material.

The present invention also provides for a composition comprising an associative polymer and a water compatible polymer and cellulose fiber.

The present invention also provides for a composition comprising an associative polymer, water compatible polymer, a siliceous material and cellulose fiber.

The use of multi-component systems in the manufacture of paper and paperboard provides the opportunity to enhance performance by utilizing materials that have different effects on the process and/or product. Moreover, the combinations may provide properties unobtainable with the components individually. Synergistic effects occur in the multi component systems of the present invention.

It is also observed that the use of the associative polymer as a retention and drainage aid has an impact on the performance of other additives in the papermaking system. Improved retention and/or drainage can have both a direct and indirect impact. A direct impact refers to the retention and drainage aid acting to retain the additive. An indirect impact refers to the efficacy of the retention and drainage aid to retain filler and fines onto which the additive is attached by either physical or chemical means. Thus, by increasing the amount of filler or fines retained in the sheet, the amount of additive retained is increased in a concomitant manner. The term filler refers to particulate materials, typically inorganic in nature, that are added to the cellulosic pulp slurry to provide certain attributes or be a lower cost substitute of a portion of the cellulose fiber. Their relatively small size, on the order of 0.2 to 10 microns, low aspect ratio and chemical nature results in their not being adsorbed onto the large fibers yet too small to be entrapped in the fiber network that is the paper sheet. The term “fines” refers to small cellulose fibers or fibrils, typically less than 0.2 mm in length and/or ability to pass through a 200 mesh screen.

As the use level of the retention and drainage aid increases the amount of additive retained in the sheet increases. This can provide either an enhancement of the property, providing a sheet with increased performance attribute, or allows the papermaker to reduce the amount of additive added to the system, reducing the cost of the product. Moreover, the amount of these materials in the recirculating water, or whitewater, used in the papermaking system is reduced. This reduced level of material, that under some conditions can be considered to be an undesirable contaminant, can provide a more efficient papermaking process or reduce the need for scavengers or other materials added to control the level of undesirable material.

The term additive, as used herein, refers to materials added to the paper slurry to provide specific attributes to the paper and/or improve the efficiency of the papermaking process. These materials include, but are not limited to, sizing agents, wet strength resins, dry strength resins, starch and starch derivatives, dyes, contaminant control agents, antifoams, and biocides.

The associative polymer useful in the present invention can be described as follows:

A water-soluble copolymer composition comprising the formula: [symbol]
B-co-F [symbol] (I)
wherein B is a nonionic polymer segment formed from the polymerization of one or more ethylenically unsaturated nonionic monomers; F is an anionic, cationic or a combination of anionic and cationic polymer segment(s) formed from polymerization of one or more ethylenically unsaturated anionic and/or cationic monomers; the molar % ratio of B:F is from 95:5 to 5:95; and the water-soluble copolymer is prepared via a water-in-oil emulsion polymerization technique that employs at least one emulsification surfactant consisting of at least one diblock or triblock polymeric surfactant wherein the ratio of the at least one diblock or triblock surfactant to monomer is at least about 3:100 and wherein; the water-in-oil emulsion polymerization technique comprises the steps of: (a) preparing an aqueous solution of monomers, (b) contacting the aqueous solution with a hydrocarbon liquid containing surfactant or surfactant mixture to form an inverse emulsion, (c) causing the monomer in the emulsion to polymerize by free radical polymerization at a pH range of from about 2 to less than 7.

The associative polymer can be an anionic copolymer. The anionic copolymer is characterized in that the Huggins' constant (k′) determined between 0.0025 wt. % to 0.025 wt. % of the copolymer in 0.01M NaCl is greater than 0.75 and the storage modulus (G′) for a 1.5 wt. % actives copolymer solution at 4.6 Hz greater than 175 Pa.

The associative polymer can be a cationic copolymer. The cationic copolymer is characterized in that its Huggins' constant (k′) determined between 0.0025 wt. % to 0.025 wt. % of the copolymer in 0.01M NaCl is greater than 0.5; and it has a storage modulus (G′) for a 1.5 wt. % actives copolymer solution at 6.3 Hz greater than 50 Pa.

The associative polymer can be an amphoteric copolymer. The amphoteric copolymer is characterized in that its Huggins' constant (k′) determined between 0.0025 wt. % to 0.025 wt. % of the copolymer in 0.01 M NaCl is greater than 0.5; and the copolymer has a storage modulus (G′) for a 1.5 wt. % actives copolymer solution at 6.3 Hz greater than 50 Pa.

Inverse emulsion polymerization is a standard chemical process for preparing high molecular weight water-soluble polymers or copolymers. In general, an inverse emulsion polymerization process is conducted by 1) preparing an aqueous solution of the monomers, 2) contacting the aqueous solution with a hydrocarbon liquid containing appropriate emulsification surfactant(s) or surfactant mixture to form an inverse monomer emulsion, 3) subjecting the monomer emulsion to free radical polymerization, and, optionally, 4) adding a breaker surfactant to enhance the inversion of the emulsion when added to water.

Inverse emulsions polymers are typically water-soluble polymers based upon ionic or non-ionic monomers. Polymers containing two or more monomers, also referred to as copolymers, can be prepared by the same process. These co-monomers can be anionic, cationic, zwitterionic, nonionic, or a combination thereof.

Typical nonionic monomers, include, but are not limited to, acrylamide; methacrylamide; N-alkylacrylamides, such as N-methylacrylamide; N,N-dialkylacrylamides, such as N,N-dimethylacrylamide; methyl acrylate; methyl methacrylate; acrylonitrile; N-vinyl methylacetamide; N-vinyl formamide; N-vinyl methyl formamide; vinyl acetate; N-vinyl pyrrolidone; hydroxyalky(meth)acrylates such as hydroxyethyl(meth)acrylate or hydroxypropyl(meth)acrylate; mixtures of any of the foregoing and the like.

Nonionic monomers of a more hydrophobic nature can also be used in the preparation of the associative polymer. The term ‘more hydrophobic’ is used here to indicate that these monomers have reduced solubility in aqueous solutions; this reduction can be to essentially zero, meaning that the monomer is not soluble in water. It is noted that the monomers of interest are also referred to as polymerizable surfactants or surfmers. These monomers include, but are not limited to, alkylacryamides; ethylenically unsaturated monomers that have pendant aromatic and alkyl groups, and ethers of the formula CH₂═CR′CH₂OAₘR where R′ is hydrogen or methyl; A is a polymer of one or more cyclic ethers such as ethyleneoxide, propylene oxide and/or butylene oxide; and R is a hydrophobic group; vinylalkoxylates; allyl alkoxylates; and allyl phenyl polyolether sulfates. Exemplary materials include, but are not limited to, methylmethacrylate, styrene, t-octyl acrylamide, and an allyl phenyl polyol ether sulfate marketed by Clariant as Emulsogen APG 2019.

Exemplary anionic monomers include, but are not limited to, the free acids and salts of: acrylic acid; methacrylic acid; maleic acid; itaconic acid; acrylamidoglycolic acid; 2-acrylamido-2-methyl-1-propanesulfonic acid; 3-allyloxy-2-hydroxy-1-propanesulfonic acid; styrenesulfonic acid; vinylsulfonic acid; vinylphosphonic acid; 2-acrylamido-2-methylpropane phosphonic acid; mixtures of any of the foregoing and the like.

Exemplary cationic monomers include, but are not limited to, cationic ethylenically unsaturated monomers such as the free base or salt of: diallyldialkylammonium halides, such as diallyidimethylammonium chloride; the (meth)acrylates of dialkylaminoalkyl compounds, such as dimethylaminoethyl(meth)acrylate, diethylaminoethyl(meth)acrylate, dimethyl aminopropyl(meth)acrylate, 2-hydroxydimethyl aminopropyl(meth)acrylate, aminoethyl(meth)acrylate, and the salts and quaternaries thereof; the N,N-dialkylaminoalkyl(meth)acrylamides, such as N,N-dimethylaminoethylacrylamide, and the salts and quaternaries thereof and mixture of the foregoing and the like.

The co-monomers may be present in any ratio. The resultant associative polymer can be non-ionic, cationic, anionic, or amphoteric (contains both cationic and anionic charge).

The molar ratio of nonionic monomer to anionic monomer (B:F or Formula I) may fall within the range of 95:5 to 5:95, preferably the range is from about 75:25 to about 25:75 and even more preferably the range is from about 65:35 to about 35:65 and most preferably from about 60:40 to about 40:60. In this regard, the molar percentages of B and F must add up to 100%. It is to be understood that more than one kind of nonionic monomer may be present in the Formula I. It is also to be understood that more than one kind of anionic monomer may be present in the Formula I.

In one preferred embodiment of the invention the associative polymer, when it is an anionic copolymer, is defined by Formula I where B, the nonionic polymer segment, is the repeat unit formed after polymerization of acrylamide; and F, the anionic polymer segment, is the repeat unit formed after polymerization of a salt or free acid of acrylic acid and the molar percent ratio of B:F is from about 75:25 to about 25:75

The physical characteristics of the associative polymer, when it is an anionic copolymer, are unique in that their Huggins' constant (k′) as determined in 0.01 M NaCl is greater than 0.75 and the storage modulus (G′) for a 1.5 wt. % actives polymer solution at 4.6 Hz is greater than 175 Pa, preferably greater than 190 and even more preferably greater than 205. The Huggins' constant is greater than 0.75, preferably greater than 0.9 and even more preferably greater than 1.0

The molar ratio of nonionic monomer to cationic monomer (B:F of Formula I) may fall within the range of 99:1 to 50:50, or 95:5 to 50:50, or 95:5 to 75:25, or 90:10 to 60:45, preferably the range is from about 85:15 to about 60:40 and even more preferably the range is from about 80:20 to about 50:50. In this regard, the molar percentages of B and F must add up to 100%. It is to be understood that more than one kind of nonionic monomer may be present in the Formula I. It is also to be understood that more than one kind of cationic monomer may be present in the Formula I.

With respect to the molar percentages of the amphoteric copolymers of Formula I, the minimum amount of each of the anionic, cationic and non-ionic monomer is 1% of the total amount of monomer used to form the copolymer. The maximum amount of the non-ionic, anionic or cationic is 98% of the total amount of monomer used to form the copolymer. Preferably the minimum amount of any of anionic, cationic and non-ionic monomer is 5%, more preferably the minimum amount of any of anionic, cationic and non-ionic monomer is 7% and even more preferably the minimum amount of any of anionic, cationic and non-ionic monomer is 10% of the total amount of monomer used to form the copolymer. In this regard, the molar percentages of anionic, cationic and non-ionic monomer must add up to 100%. It is to be understood that more than one kind of nonionic monomer may be present in the Formula I, more than one kind of cationic monomer may be present in the Formula I, and that more than one kind of anionic monomer may be present in the Formula I.

The physical characteristics of the associative polymer, when it is a cationic or amphoteric copolymer, are unique in that their Huggins' constant (k′) as determined in 0.01 M NaCl is greater than 0.5 and the storage modulus (G′) for a 1.5 wt. % actives polymer solution at 6.3 Hz is greater than 50 Pa, preferably greater than 10 and even more preferably greater than 25, or greater than 50, or greater than 100, or greater than 175, or greater than 200. The Huggins' constant is greater than 0.5, preferably greater than 0.6, or greater than 0.75, or greater than 0.9 or greater than 1.0.

The emulsification surfactant or surfactant mixture used in an inverse emulsion polymerization system have an important effect on both the manufacturing process and the resultant product. Surfactants used in emulsion polymerization systems are known to those skilled in the art. These surfactants typically have a range of HLB (Hydrophilic Lipophilic Balance) values that is dependent on the overall composition. One or more emulsification surfactants can be used. The emulsification surfactant(s) of the polymerization products that are used to produce the associative polymer include at least one diblock or triblock polymeric surfactant. It is known that these surfactants are highly effective emulsion stabilizers. The choice and amount of the emulsification surfactant(s) are selected in order to yield an inverse monomer emulsion for polymerization. Preferably, one or more surfactants are selected in order to obtain a specific HLB value.

Diblock and triblock polymeric emulsification surfactants are used to provide unique materials. When the diblock and triblock polymeric emulsification surfactants are used in the necessary quantity, unique polymers exhibiting unique characteristic result, as described in WO 03/050152 A1 and US 2004/0143039 A1, the entire contents of each is herein incorporated by reference. Exemplary diblock and triblock polymeric surfactants include, but are not limited to, diblock and triblock copolymers based on polyester derivatives of fatty acids and poly[ethyleneoxide] (e.g., Hypermer® B246SF, Uniqema, New Castle, Del.), diblock and triblock copolymers based on polyisobutylene succinic anhydride and poly[ethyleneoxide], reaction products of ethylene oxide and propylene oxide with ethylenediamine, mixtures of any of the foregoing and the like. Preferably the diblock and triblock copolymers are based on polyester derivatives of fatty acids and poly[ethyleneoxide]. When a triblock surfactant is used, it is preferable that the triblock contains two hydrophobic regions and one hydrophilic region, i.e., hydrophobe-hydrophile-hydrophobe.

The amount (based on weight percent) of diblock or triblock surfactant is dependent on the amount of monomer used to form the associative polymer. The ratio of diblock or triblock surfactant to monomer is at least about 3 to 100. The amount of diblock or triblock surfactant to monomer can be greater than 3 to 100 and preferably is at least about 4 to 100 and more preferably 5 to 100 and even more preferably about 6 to 100. The diblock or triblock surfactant is the primary surfactant of the emulsification system.

A secondary emulsification surfactant can be added to ease handling and processing, to improve emulsion stability, and/or to alter the emulsion viscosity. Examples of secondary emulsification surfactants include, but are not limited to, sorbitan fatty acid esters, such as sorbitan monooleate (e.g., Atlas G-946, Uniqema, New Castle, Del.), ethoxylated sorbitan fatty acid esters, polyethoxylated sorbitan fatty acid esters, the ethylene oxide and/or propylene oxide adducts of alkylphenols, the ethylene oxide and/or propylene oxide adducts of long chain alcohols or fatty acids, mixed ethylene oxide/propylene oxide block copolymers, alkanolamides, sulfosuccinates and mixtures thereof and the like.

Polymerization of the inverse emulsion may be carried out in any manner known to those skilled in the art. Examples can be found in many references, including, for example, Allcock and Lampe, Contemporary Polymer Chemistry, (Englewood Cliffs, New Jersey, PRENTICE-HALL, 1981), chapters 3-5.

A representative inverse emulsion polymerization is prepared as follows. To a suitable reaction flask equipped with an overhead mechanical stirrer, thermometer, nitrogen sparge tube, and condenser is charged an oil phase of paraffin oil (135.0 g, Exxsol® D80 oil, Exxon—Houston, Tex.) and surfactants (4.5 g Atlas® G-946 and 9.0 g Hypermer® B246SF). The temperature of the oil phase is then adjusted to 37° C.

An aqueous phase is prepared separately which comprised 53-wt. % acrylamide solution in water (126.5 g), acrylic acid (68.7 g), deionized water (70.0 g), and Versenex® 80 (Dow Chemical) chelant solution (0.7 g). The aqueous phase is then adjusted to pH 5.4 with the addition of ammonium hydroxide solution in water (33.1 g, 29.4 wt. % as NH₃). The temperature of the aqueous phase after neutralization is 39° C.

The aqueous phase is then charged to the oil phase while simultaneously mixing with a homogenizer to obtain a stable water-in-oil emulsion. This emulsion is then mixed with a 4-blade glass stirrer while being sparged with nitrogen for 60 minutes. During the nitrogen sparge the temperature of the emulsion is adjusted to 50±1° C. Afterwards, the sparge is discontinued and a nitrogen blanket implemented.

The polymerization is initiated by feeding a 3-wt. % solution of 2,2′-azobisisobutyronitrile (AlBN) in toluene (0.213 g). This corresponds to an initial AlBN charge, as AlBN, of 250 ppm on a total monomer basis. During the course of the feed the batch temperature was allowed to exotherm to 62° C. (˜50 minutes), after which the batch was maintained at 62±1° C. After the feed the batch was held at 62±1° C. for 1 hour. Afterwards 3-wt. % AIBN solution in toluene (0.085 g) is then charged in under one minute. This corresponds to a second AlBN charge of 100 ppm on a total monomer basis. Then the batch is held at 62±1° C. for 2 hours. Then batch is then cooled to room temperature, and breaker surfactant(s) is added.

The associative polymer emulsion is typically inverted at the application site resulting in an aqueous solution of 0.1 to 1% active copolymer. This dilute solution of the associative polymer is then added to the paper process to affect retention and drainage. The associative polymer may be added to the thick stock or thin stock, preferably the thin stock. The associative polymer may be added at one feed point, or may be split fed such that the associative polymer is fed simultaneously to two or more separate feed points. Typical stock addition points include feed point(s) before the fan pump, after the fan pump and before the pressure screen, or after the pressure screen.

The associative polymer may be added in any effective amount to achieve flocculation. The amount of copolymer could be more than 0.5 Kg per metric ton of cellulosic pulp (dry basis). Preferably, the associative polymer is employed in an amount of at least about 0.03 lb. to about 0.5 Kg. of active copolymer per metric ton of cellulosic pulp, based on the dry weight of the pulp. The concentration of copolymer is preferably from about 0.05 to about 0.5 Kg of active copolymer per metric ton of dried cellulosic pulp. More preferably the copolymer is added in an amount of from about 0.05 to 0.4 Kg per metric ton cellulose pulp and, most preferably, about 0.1 to about 0.3 Kg per metric ton based on dry weight of the cellulosic pulp.

The second component of the retention and drainage system can be another water compatible polymer. By water compatible we mean that the polymer can be water soluble or water swellable or water dispersible.

The term water soluble is used to indicate that the polymer will dissolve in the solvent, with no visible solid material remaining in the solvent. Solubility of a polymer in a solvent occurs when the free energy of mixing is negative. The water soluble materials can be an exudate or gum, extractive, natural, modified natural, or synthetic material. An example of each group would be gum tragacanth, pectin, guar, derivatived cellulose such as methylcellulose, and poly(acrylic acid). The synthetic polymers can be comprised of one or more monomers selected to provide specific properties to the final polymer.

Water swellable polymers are those that can imbibe the aqueous solvent and swell, but to a limited extent that is influenced by a number of factors that includes crosslinking. Thus, the interactions between polymer and solvent are limited and although a visible homogeneous solution is obtained, a uniform molecular dispersion can not be attained. An example is a crosslinked polymer. They can be water compatible and water dispersible. Branching, on the other hand, does not have a negative impact on solubility.

Water dispersable materials are those that are not soluble in water, but do not phase separate. Typically, these materials have a modified surface that allows them to remain as discrete particulate material that is suspended in water, or can be made dispersible by the addition of other materials. Examples include latex particle, oil-in-water emulsions, and dispersed clays or pigments.

Latex particles are used within the paper industry to provide specific functional properties. A latex is defined as a stable colloidal dispersion of a polymeric substance in an aqueous medium. The polymer particles are usually approximately spherical and of typical colloidal dimensions; particle diameters can be up to several microns. The volume fraction of polymer in the dispersion can be as high as 70 percent. The dispersion medium is usually a dilute aqueous solution containing substances such as electrolytes, surface-active compounds, hydrophilic polymers, and initiator residues. The preferred plural of latex is latices, but the alternative latexes is widely used in the art. Polymer latices are usually white mobile liquids whose viscosity is lower than that of a typical polymer solution of equal concentration. Polymer latices are also know as polymer colloids or polymer emulsions.

Polymeric latices are classified in various ways, including by origin, such as synthetic latices, produced by the emulsion polymerization of monomers; and artificial latices, produced by dispersing a polymer in a dispersion medium. Latices are also classified according to the physical nature of the polymer: such as rubber latices.

Latices may also be classified according to the chemical nature of the polymer. Exemplary materials include, but are not limited to, styrene-butadiene copolymer latex, known in the art as SBR, polystyrene latex, polychloroprene latex and acrylonitrile-butadiene copolymer latex.

A fourth criterion by which copolymer latices can be classified by the electric charge carried by the particles at their surfaces. In this case, the categories are anionic latices, where the particles carry negative electric charges; cationic latices, where the particles carry positive electric charges; and nonionic latices, where the particles are essentially uncharged. It is contemplated that copolymer lattices comprising both anionic and cationic monomers might appear to be nonionic (the positive and negative charges being balance to produce an uncharged polymer). Alternatively the copolymer lattices could have a net positive or a net negative charge depending on the molar ratio of the monomers.

The charge surface can be a consequence of the use of ionic monomer(s) or the use of ionic surfactant used in preparation of the latex particles. Alternatively, the nature of the latex particle surface can be modified, after polymerization by use of surfactants or water compatible polymers.

Synthetic latices are produced from monomers by emulsion polymerization. A simple satisfactory definition of an emulsion polymerization reaction which embraces all types of reaction recognized as such is difficult. A reasonable definition would be a polymerization reaction that forms a stable lyophobic colloid, i.e., a polymer colloid or latex, but this definition clearly implies some degree of circularity.

Information and examples of latex reaction can be found in a number of references, including, for example, D. C. Blackley in Encyclopedia of Polymer Science and Engineering, 2^{nd} Edition, Wiley-Interscience, 1987, Vol 8, Pg. 647-677 and D. C. Blackley, Polymer Latices: Science and Technology, 2^{nd} Edition, Volumes 1 to 3, Chapman & Hall, London, 1997.

Examples of water compatible polymers useful in the present invention include but are not limited to natural materials such as guar and pectin, modified natural products such as carboxymethylcellulose, hydroxyethyl cellulose, hydroxypropyl cellulose, methylcellulose, hydroxyethyl guar, hydroxypropyl guar, and poly(acrylic acid). Synthetic water compatible polymers useful in the present invention include but are not limited to materials such as polymers of the free acids and salts of: acrylic acid; methacrylic acid, styrene sulfonic acid, 2-acrylamido-2-methylpropane sulfonic acid; the free bases of salts of diallyldialkylammonium halides, such as diallyldimethylammonium chloride; polymers comprising monomers such as ethylene oxide, propylene oxide, acrylamide and vinyl alcohol; and latex materials. One or more water compatible polymers can be used in the present invention.

The second component of the retention and drainage system can be added at amounts up to 20 Kg of active material per metric ton of cellulose pulp based on dry weight of the pulp, with the ratio of the associative polymer to second component being 1:100 to 100:1. It is contemplated that more than one second component can be used in the papermaking system.

It is contemplated that the combined use of the associative polymer and the water compatible polymer can provide enhancement of other performance attributes provided by the water compatible polymer. This unexpected result may be a consequence of improved retention but, alternatively, can be a result of a synergistic interaction.

Optionally siliceous materials can be used as an additional component of a retention and drainage aid used in making paper and paperboard. The siliceous material may be any of the materials selected from the group consisting of silica based particles, silica microgels, amorphous silica, colloidal silica, anionic colloidal silica, silica sols, silica gels, polysilicates, polysilicic acid, and the like. These materials are characterized by the high surface area, high charge density and submicron particle size.

This group includes stable colloidal dispersion of spherical amorphous silica particles, referred to in the art as silica sols. The term sol refers to a stable colloidal dispersion of spherical amorphous particles. Silica gels are three dimensional silica aggregate chains, each comprising several amorphous silica sol particles, that can also be used in retention and drainage aid systems; the chains may be linear or branched. Silica sols and gels are prepared by polymerizing monomeric silicic acid into a cyclic structure that result in discrete amorphous silica sols of polysilicic acid. These silica sols can be reacted further to produce a three dimensional gell network. The various silica particles (sols, gels, etc.) can have an overall size of 5-50 nm. Anionic colloidal silica can also be used.

The siliceous material can be added to the cellulosic suspension in an amount of at least 0.005 Kg per metric ton based on dry weight of the cellulosic suspension. The amount of siliceous material may be as high at 50 Kg per metric ton. Preferably, the amount of siliceous material is from about 0.05 to about 25 Kg per metric ton. Even more preferably, the amount of siliceous material is from about 0.25 to about 5 Kg per metric ton based on the dry weight of the cellullosic suspension.

Optionally, an additional component of the retention and drainage aid system can be a conventional flocculant. A conventional flocculant is generally a linear cationic or anionic copolymer of acrylamide. The additional component of the retention and drainage system is added in conjunction with the aluminum compound and the associative polymer to provide a multi-component system which improves retention and drainage.

The conventional flocculant can be an anionic, cationic or non-ionic polymer. The ionic monomers are most often used to make copolymers with a non-ionic monomer such as acrylamide. These polymers can be provided by a variety of synthetic processes including, but not limited to, suspension, dispersion and inverse emulsion polymerization. For the last process, a microemulsion may also be used.

The co-monomers of the conventional flocculant may be present in any ratio. The resultant copolymer can be non-ionic, cationic, anionic, or amphoteric (contains both cationic and anionic charge).

Yet other additional components that can be part of the inventive system are aluminum sources, such as alum (aluminum sulfate), polyaluminum sulfate, polyaluminum chloride and aluminum chlorohydrate.

The components of a retention and drainage system may be added substantially simultaneously to the cellulosic suspension. The term retention and drainage system is used here to encompass two or more distinct materials added to the papermaking slurry to provide improved retention and drainage. For instance, the components may be added to the cellulosic suspension separately either at the same stage or dosing point or at different stages or dosing points. When the components of the inventive system are added simultaneously any two of more of the materials may be added as a blend. The mixture may be formed in-situ by combining the materials at the dosing point or in the feed line to the dosing point. Alternatively the inventive system comprises a preformed blend of the materials. In an alternative form of the invention the components of the inventive system are added sequentially. A shear point may or may not be present between the addition points of the components. The components can be added in any order.

The inventive system is typically added to the paper process to affect retention and drainage. The inventive system may be added to the thick stock or thin stock, preferably the thin stock. The system may be added at one feed point, or may be split fed such that the inventive system is fed simultaneously to two or more separate feed points. Typical stock addition points include feed points(s) before the fan pump, after the fan pump and before the pressure screen, or after the pressure screen.

### EXAMPLES

To evaluate the performance of the present invention, a series of drainage tests were conducted utilizing a synthetic alkaline furnish. This furnish is prepared from hardwood and softwood dried market lap pulps, and from water and further materials. First, the hardwood and softwood dried market lap pulp are refined separately. These pulps are then combined at a ratio of about 70 percent by weight of hardwood to about 30 percent by weight of softwood in an aqueous medium. The aqueous medium utilized in preparing the furnish comprises a mixture of local hard water and deionized water to a representative hardness. Inorganic salts are added in amounts so as to provide this medium with a total alkalinity of 75 ppm as CaCO₃ and hardness of 100 ppm as CaCO₃. Precipitated calcium carbonate (PCC) is introduced into the pulp furnish at a representative weight percent to provide a final furnish containing 80% fiber and 20% PCC filler. The drainage tests were conducted by mixing the furnish with a mechanical mixer at a specified mixer speed, and introducing the various chemical components into the furnish and allowing the individual components to mix for a specified time prior to the addition of the next component. The specific chemical components and dosage levels are described in the data tables. The drainage activity of the invention was determined utilizing the Canadian Standard Freeness (CSF). The CSF test, a commercially available device (Lorentzen & Weftre, Stockholm, Sweden), can be utilized to determine relative drainage rate or dewatering rate is also known in the art; standard test method (TAPPI Test Procedure T-227) is typical. The CSF device consists of a drainage chamber and a rate measuring funnel, both mounted on a suitable support. The drainage chamber is cylindrical, fitted with a perforated screen plate and a hinged plate on the bottom, and with a vacuum tight hinged lid on the top. The rate-measuring funnel is equipped with a bottom orifice and a side, overflow orifice.

The CSF drainage tests are conducted with 1 liter of the furnish. The furnish is prepared for the described treatment externally from the CSF device in a square beaker to provide turbulent mixing. Upon completion of the addition of the additives and the mixing sequence, the treated furnish is poured into the drainage chamber, closing the top lid, and them immediately opening the bottom plate. The water is allowed to drain freely into the rate-measuring funnel; water flow that exceeds that determined by the bottom orifice will overflow through the side orifice and is collected in a graduated cylinder. The values generated are described in milliliters (ml) of filtrate; higher quantitative values represent higher levels of drainage or dewatering.

The tables (below) illustrate the utility of the invention. The test samples were prepared as follows: the furnish prepared as described above, is added, first, 5 Kg of cationic starch (Stalok® 400, AE., Staley, Decatur, Ill.) per metric ton of furnish (dry basis), and then 2.5 Kg of alum (aluminum sulfate octadecahydrate obtained from Delta Chemical Corporation, Baltimore, Md. as a 50% solution) per metric ton of furnish (dry basis) is added, followed by 0.25 Kg of PerForm® PC8138 cationic polymer (Hercules Incorporated, Wilmington, Del.) per metric ton of furnish (dry basis). The additive(s) of interest, as noted in the table were then added in the examples provided in the tables. SP9232 is PerForm® SP9232, a retention and drainage aid produced under certain conditions (see PCT WO 03/050152 A), is a product of Hercules Incorporated, Wilmington, Del.; silica is NP780 colloidal silica (Eka Chemical, Marietta, Ga.); MC is microcrystalline cellulose (Aldrich, Milwaukee, Wis.); AL is an anionic latex (Airflex® 4530, a product of Air Products Polymers, L.P., Allentown, Pa.); Lignin is Norlig® 42C sodium lignosulfonate (Borregaard Lignotech USA, Rothschild, Wis.); pectin is Slendid® 100 pectin, a product of CP Kelco, Wilmington, Del.; PD is Zenix® DC7888 protein detackifier (Hercules Incorporated, Wilmington, Del.); HASE is Acusol® 842 emulsion (an acrylic-based hydrophobically associative solubilized emulsion produced by Rohm & Haas, Philadelphia, Pa.); PEO is PB8714 poly(ethylene oxide) (Hercules Incorporated, Wilmington, Del.); and silica is BMA 780, a colloidal silica product of the Nalco Company, Naperville, Ill.

Table 1 shows the data for microcrystalline cellulose.

TABLE 1

| | Additive(s) | Addition | CSF Freeness |
|---|---|---|---|
| Example | of Interest^{(a)} | Scheme^{(b)} | (ml) |
| 1 | None | — | 464 |
| 2 | SP9232 | — | 647 |
| 3 | Silica | — | 641 |
| 4 | MC | — | 457 |
| 5 | MC/SP9232 | SIM | 659 |
| 6 | MC/Silica/SP9232 | SIM | 709 |
| 7 | MC/SP9232 | SEQ | 648 |
| 8 | MC/Silica/SP9232 | SEQ | 712 |

^{(a)}The use levels of Silica and SP9232 are added at 0.25 Kg per metric ton of furnish (dry basis) and MC is added at 0.5 Kg per metric ton of furnish (dry basis)
^{(b)}SIM indicates simultaneous addition; SEQ indicates sequential addition

These data indicate that microcrystalline cellulose provides a significant improvement with use in conjunction with PerForm® 8P9232.

TABLE 2

| | Additive(s) | Addition | CSF Freeness |
|---|---|---|---|
| Example | of Interest^{(a)} | Scheme^{(b)} | (ml) |
| 9 | None | — | 435 |
| 10 | SP9232 | — | 608 |
| 11 | Silica | — | 606 |
| 12 | AL | — | 467 |
| 13 | Lignin | — | 484 |
| 14 | Pectin | — | 465 |
| 15 | PD | — | 401 |
| 16 | AL/SP9232 | SIM | 623 |
| 17 | AL/Silica/SP9232 | SIM | 677 |
| 18 | AL/SP9232 | SEQ | 631 |
| 19 | AL/Silica/SP9232 | SEQ | 661 |
| 20 | Lignin/SP9232 | SIM | 631 |
| 21 | Lignin/Silica/SP9232 | SIM | 649 |
| 22 | Lignin/SP9232 | SEQ | 629 |
| 23 | Lignin/Silica/SP9232 | SEQ | 665 |
| 24 | Pectin/SP9232 | SIM | 604 |
| 25 | Pectin/Silica/SP9232 | SIM | 654 |
| 26 | Pectin/SP9232 | SEQ | 611 |
| 27 | Pectin/Silica/SP9232 | SEQ | 653 |
| 28 | PD/SP9232 | SIM | 629 |
| 29 | PD/Silica/SP9232 | SIM | 673 |
| 30 | PD/SP9232 | SEQ | 617 |
| 31 | PD/Silica/SP9232 | SEQ | 678 |

^{(a)}The use level of silica and SP is 0.25 Kg per metric ton of furnish (dry basis), the use level of AL is 5 Kg per metric ton of furnish (dry basis); the use level of pectin and lignin are 2.5 Kg per metric ton of furnish (dry basis) and PD is used as 0.5 Kg per metric ton (dry basis),
^{(b)}SIM indicates simultaneous addition and SEQ indicates sequential.

The data in Table 2 indicate that the use of anionic latex improves the drainage performance of PerForm® SP9232. The data indicate that the other polymers all provide an incremental increase in drainage over that attained with either SP9232 or silica. The combination of all three, moreover, is consistent better than the individual retention aid. Finally, both simultaneous and sequential additions are effective.

TABLE 3

| | | Addition | CSF Freeness |
|---|---|---|---|
| Example | Additive(s)(a) | Scheme^{(b)} | (ml) |
| 32 | — | — | 430 |
| 33 | SP9232 | — | 654 |
| 34 | Silica | — | 606 |
| 35 | HASE | — | 583 |
| 36 | HASE/SP9232 | SIM | 643 |
| 37 | HASE/Silica/SP9232 | SIM | 682 |
| 38 | HASE/SP9232 | SEQ | 638 |
| 39 | HASE/Silica/SP9232 | SEQ | 675 |
| 40 | PEO | 393 | |
| 41 | PEO/SP9232 | SIM | 615 |
| 42 | PEO/Silica/SP9232 | SIM | 672 |
| 43 | PEO/SP9232 | SEQ | 625 |
| 44 | PEO/Silica/SP9232 | SEQ | 675 |

^{(a)}The use level of silica and SP9232 is 0.25 Kg per metric ton of furnish (dry basis), the use level of HASE is 2.5 Kg per metric ton of furnish (dry basis); the use level of PEO is 0.5 Kg per metric ton of furnish (dry basis).
^{(b)}SIM indicates simultaneous addition and SEQ indicates sequential addition.

1. A method of improving retention and drainage in a papermaking process wherein the improvement comprising adding to a papermaking slurry, an associative polymer and at least one water compatible polymer, wherein the associative polymer comprising the formula: [symbol]
B-co-F [symbol] (I)
wherein B is a nonionic polymer segment comprising one or more ethylenically unsaturated nonionic monomers; F is an polymer segment comprising at least one ethylenically unsaturated anionic or cationic monomer; and the molar percent ratio of B:F is 99:1 to 1:99 and wherein the associative polymer has associative properties provided by an effective amount of at least emulsification surfactant chosen from diblock or triblock polymeric surfactants, and wherein the amount of the at least one diblock or triblock surfactant to monomer is at least about 3:10.

2. The method of claim 1 wherein the water compatible polymer comprises a least one of guar, pectin, a modified natural product or a synthetic polymer.

3. The method of claim 2 wherein the water compatible polymer comprises a least one of carboxymethyl cellulose, hydroxyethylcellulose, hydroxypropyl cellulose, methylcellulose, hydroxyethylguar, and hydroxypropyl guar or poly(acrylic acid).

4. The method of claim 1 wherein the at least one water compatible polymer comprises a polymer formed from at least one monomer selected from the group consisting of the free acid or salt of: acrylic acid, methacrylic acid, styrene sulfonic acid, and 2-acrylamido-2-methylpropane sulfonic acid.

5. The method of claim 1 wherein the at least one water compatible polymer comprises a polymer formed from at least one monomer selected from the group consisting of the free bases or salts of diallyldimethylammonium chloride; dimethylaminoethyl(meth)acrylate, diethylaminoethyl(meth)acrylate, dimethyl aminopropyl(meth)acrylate, 2-hydroxydimethyl aminopropyl(meth)acrylate, aminoethyl(meth)acrylate, and the quaternaries thereof.

6. The method of claim 1 wherein the water compatible polymer is formed from at least one monomer selected from the group consisting of ethylene oxide, acrylamide, propylene oxide, and vinyl alcohol.

7. The method in claim 1 wherein the water compatible polymer is a latex

8. The method of claim 1 further comprising adding a siliceous material.

9. The method of claim 8 wherein the siliceous material is selected from the group consisting of silica based particles, silica microgels, amorphous silica, colloidal silica, anionic colloidal silica, silica sols, silica gels, polysilicates, polysilicic acid, and combinations thereof.

10. The method of claim 1 wherein the water compatible polymer and associative polymer are added to the papermaking slurry as a blend, simultaneously or sequentially.

11. The method of claim 1 wherein the associative polymer is anionic.

12. The method of claim 1 wherein non-ionic monomer comprises acrylamide and the anionic monomer comprises a free acid or salt of acrylic acid.

13. The method of claim 1 wherein the associative polymer is cationic.

14. A composition comprising an associative polymer and at least one water compatible polymer wherein the associative polymer comprising the formula: [symbol]
B-co-F [symbol] (I)
wherein B is a nonionic polymer segment comprising one or more ethylenically unsaturated nonionic monomers; F is an polymer segment comprising at least one ethylenically unsaturated anionic or cationic monomer; and the molar percent ratio of B:F is 99:1 to 1:99 and wherein the associative polymer has associative properties provided by an effective amount of at least emulsification surfactant chosen from diblock or triblock polymeric surfactants, and wherein the amount of the at least one diblock or triblock surfactant to monomer is at least about 3:10.

15. The composition of claim 15 further comprising cellulosic fiber.

16. The composition of claim 14 wherein the water compatible polymer comprises a least one of guar, pectin, a modified natural product or a synthetic polymer.

17. The composition of claim 14 wherein the water compatible polymer comprises a least one of carboxymethyl cellulose, hydroxyethylcellulose, hydroxypropyl cellulose, methylcellulose, hydroxyethylguar, and hydroxypropyl guar or poly(acrylic acid).

18. The method of claim 14 wherein the at least one water compatible polymer comprises a polymer formed from at least one monomer selected from the group consisting of the free bases or salts of diallyidimethylammonium chloride; dimethylaminoethyl(meth)acrylate, diethylaminoethyl(meth)acrylate, dimethyl aminopropyl(meth)acrylate, 2-hydroxydimethyl aminopropyl(meth)acrylate, aminoethyl(meth)acrylate, and the quaternaries thereof.

19. The method of claim 14 wherein the water compatible polymer is formed from at least one monomer selected from the group consisting of ethylene oxide, acrylamide, propylene oxide, and vinyl alcohol.

20. The method in claim 14 wherein the water compatible polymer is a latex.
